(19) United States
(12) Patent Application Publication
(10) Pub. No.: US 2026/0180702 A1
(43) Pub. Date: Jun. 25, 2026

(54) METHODS AND APPARATUSES TO SUPPORT APERIODIC CSI FOR AIML SYSTEMS

(71) Applicant: InterDigital Patent Holdings, Inc., Wilmington, DE (US)

(72) Inventors: Haseeb Ur Rehman, Winnipeg (CA); Young Woo Kwak, Woodbury, NY (US); Yugeswar Deenoo Narayanan Thangaraj, Chalfont, PA (US); Nazli Khan Beigi, Longueuil (CA)

(73) Assignee: InterDigital Patent Holdings, Inc., Wilmington, DE (US)

(21) Appl. No.: 18/987,210

(22) Filed: Dec. 19, 2024

(51) Int. Cl. H04B 17/391; H04B 7/06; H04B 17/318

(52) U.S. Cl. CPC H04B 17/3913; H04B 7/0626; H04B 7/06952; H04B 17/328

(57) ABSTRACT

A wireless transmit/receive unit (WTRU) may receive configuration information associated with one or more of a first type of report configurations, a second type of report configurations, or an input set of beams. The configuration information may include a report quantity parameter and one or more thresholds. The WTRU may determine one or more predicted beams based on one or more measured first RSs. The WTRU may activate one or more second type of report configurations based on one or more of a determined prediction quality or determined probability information associated with the one or more predicted beams. The WTRU may activate one or more RS resource sets associated with the activated one or more second type of report configurations based on one or more of an active beam or an overlap between RSs associated with the second type of report configuration and RSs associated with the predicted beams.

### BACKGROUND

In traditional beam management procedure, all the beams in a cell were transmitted and measured to identify a best beam and receive channels and signals. However, in artificial intelligence machine learning (AIML) based downlink (DL) transmit (Tx) beam prediction, reference signals (RSs) for only selected beams may be transmitted and AIML model estimates qualities of other beams based on measurements of the selected beams. This technology could be the great foundation in improving performance and complexity in conventional beam management aspects, including beam prediction in time, and/or spatial domain for overhead and latency reduction, beam selection accuracy improvement, and so forth.

### SUMMARY

Methods and apparatuses may be described herein to configure channel state information (CSI) Reports for artificial intelligence machine learning (AIML) systems. Methods and apparatuses may be described herein to configure periodic, semi-persistent, and/or aperiodic report/resources for AIML systems. Methods and apparatuses may be described herein to prepare and transmit one or more CSI Reports. Methods and apparatuses may be described herein to activate a subset of aperiodic report configurations and reference signal (RS) resource sets associated with aperiodic report configurations. Methods and apparatuses may be described herein to update beam measurements and/or predictions based on aperiodic CSI RS measurements. Methods and apparatuses may be described herein to transmit and omit beam information from periodic, semi-persistent, and aperiodic reports based on a received configuration.

A wireless transmit/receive unit (WTRU) may receive configuration information associated with a first type of report configurations associated with a first type of resource associated with a reference signal (RS) resource set associated with one or more of an output set of predicted set of beams predicted by an artificial intelligence machine learning (AIML) model or an input set of beams that are inputs to the AIML model, a second type of report configurations associated with one or more of a subset of the output set of predicted set of beams or the input set of beams. The configuration information may include a report quantity parameter and one or more thresholds associated with one or more of prediction quality or probability information. The WTRU may measure one or more first RSs associated with the first type of report configuration based on the received configuration information. The WTRU may determine one or more predicted beams based on the measured one or more first RSs. The WTRU may determine one or more of a prediction quality or probability information associated with the one or more predicted beams. The WTRU may trigger measurement associated with the second type of report configuration based on a received index of associated report configuration information list. The WTRU may activate one or more second type of report configurations based on one or more of the determined prediction quality or the determined probability information. The WTRU may activate one or more RS resource sets associated with the activated one or more second type of report configurations based on one or more of an active beam or an overlap between RSs associated with the second type of report configuration and RSs associated with the predicted beams. The WTRU may send a channel state information (CSI) report associated with the first type of report configuration.

The report quantity parameter may include one or more of an AIML CSI-RS resource indicator (AIML-cri) parameter, an AIML-cri-top1 parameter, an AIML CRI reference signal received power (AIML-cri-RSRP) parameter, an AIML-cri-RSRP-top1 parameter, a none parameter, a cri-RSRP parameter, a synchronization signal block (SSB) index-RSRP (ssb-index-RSRP) parameter, a CRI rank indicator (cri-RI) parameter, a CRI pre-coding matrix indicator (cri-PMI) parameter, or a CRI channel quality indicator (cri-CQI) parameter. The active beam may include a RS resource set associated with a RS QCL-TypeD related with a latest transmission of a physical downlink shared channel (PDSCH) and a physical downlink control channel (PDCCH). The WTRU may measure one or more second RSs of the one or more activated RS resource sets to determine second RS measurements. The WTRU may determine measured beam qualities based on the second RS measurements. The measured beam qualities may include one or more of reference signal received power (RSRP), signal to noise ratio (SINR), or noise power. The WTRU may update beam qualities of one or more first RSs associated with first type of report config and QCL-TypeD related with one or more second RSs associated with second type of report, for example, based on the second RS measurements of the activated one or more RS resource sets.

The first type of resource and the first type of report configuration may include periodic or semi-persistent and the second type of resource. The second type of report configuration may include aperiodic. The first CSI report may include an indication indicating that beam information is updated. The WTRU may send a second CSI report associated with the second type of report configuration. The second CSI report may include beam information. The WTRU may send a third CSI report that omits the beam information transmitted in the second CSI report of a second type of report configuration. The third CSI report may include an indication indicating the omission of the beam information in the third CSI report. The WTRU may determine a type of content of beam information to be reported in the second CSI report based on report quantity parameter in the configuration information.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flow chart depicting an example method of supporting efficient configuration and reporting of aperiodic channel state information (CSI).

### DETAILED DESCRIPTION

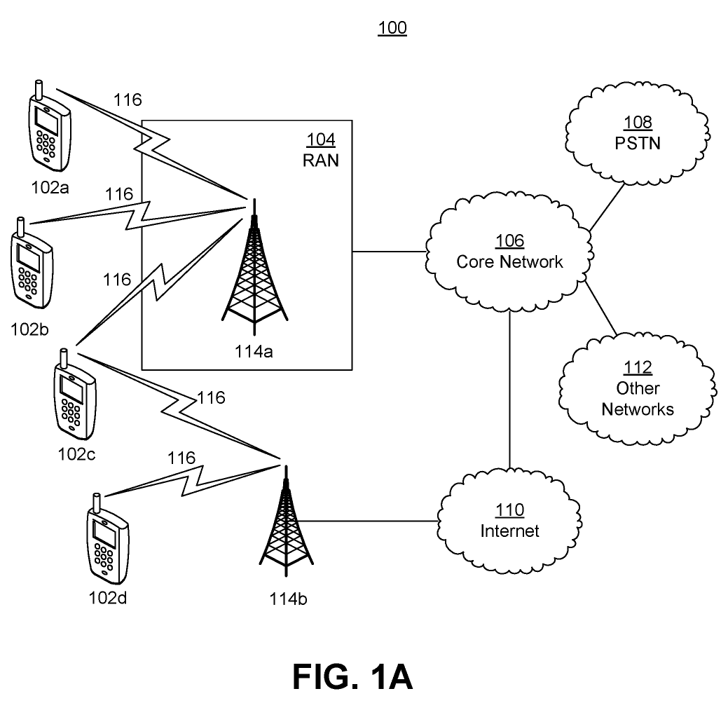

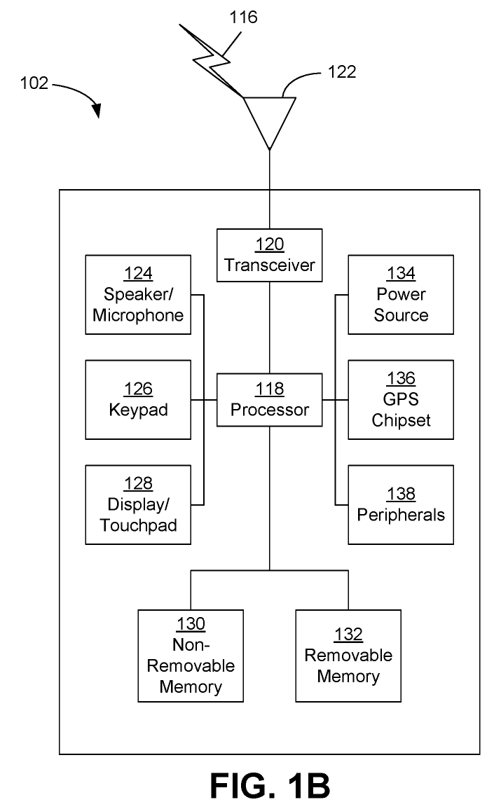

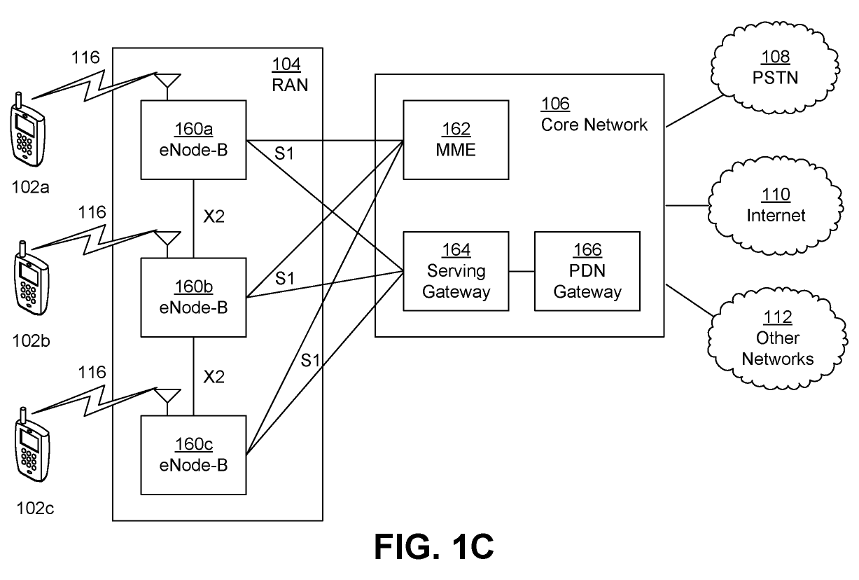

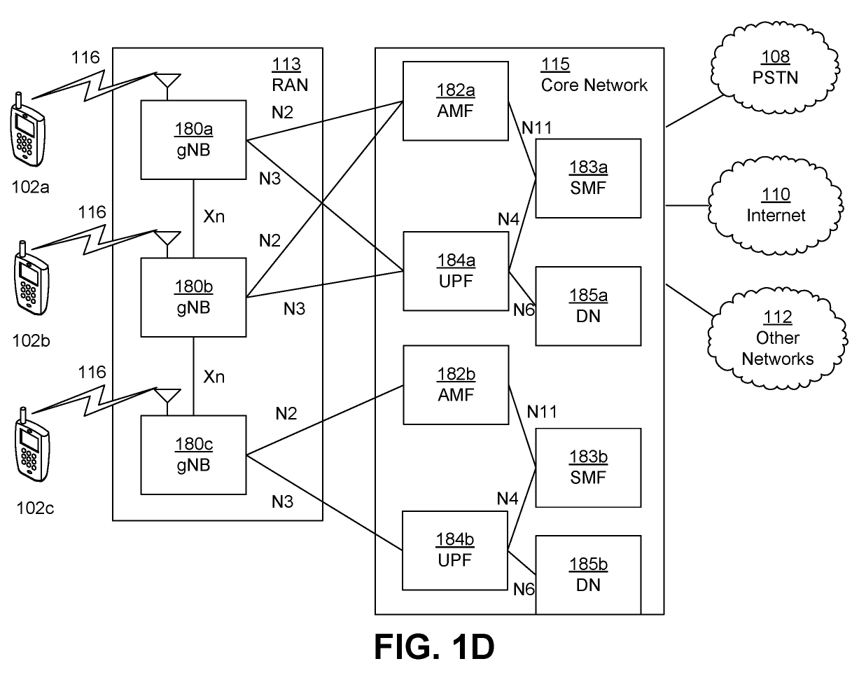

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access , which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The use case for AIML with respect to beam management is to predict one or more best beams of among a set of beams with more accuracy and less overhead than legacy beam management procedures. Another use case for AIML with respect to beam management is to predict qualities of beams including unmeasured beams based on the measured qualities of beams. In current specification for beam management, the RS signals associated with a beam are measured by the WTRU to determine the beam quality and a best beam(s) are reported among the measured beams. In contrast, an AIML model in a WTRU (or gNB) predicts one or more beams out of all possible beams including those not measured by the WTRU (or gNB). An AIML model also predicts beam qualities of unmeasured beams. The input to the AIML are a set of beam measurements associated to a set of reference signals. The input set is denoted by Set B. The AIML model predicts a best beam (e.g., a beam index) and/or qualities of beams from an output predicted set of beams, denoted by Set A. Here, Set B is a subset of Set A. Aperiodic CSI is useful for obtaining updated beam information (e.g., beam qualities) between intervals of periodic CSI. In the current specification, the WTRU measures aperiodic CSI RSs and reports beam information in an aperiodic CSI report. For temporal prediction case of AIML BM (e.g., BM-Case 2), Set B is composed of all the possible beams. It is inefficient to transmit an entire Set B RSs using aperiodic CSI because of its WTRU-specific nature (e.g., requires dedicated time-frequency resources for one WTRU). Moreover, the periodic CSI report for BM-Case 2 becomes redundant if an aperiodic CSI report is already transmitted by a WTRU since both reports contains information about the same set of beams. Therefore, a procedure for efficient/selective configuration and reporting of aperiodic CSI is beneficial.

Aperiodic CSI is useful for obtaining updated beam information (e.g., beam qualities) between intervals of periodic CSI. In the current specification, the WTRU measures aperiodic CSI RSs and reports beam information in an aperiodic CSI report.

For temporal prediction case of AIML BM (e.g., BM-Case 2), Set B may be composed of all the possible beams. It may be inefficient to transmit an entire Set B RSs using aperiodic CSI because of its WTRU-specific nature (e.g., requires dedicated time-frequency resources for one WTRU). Moreover, the periodic CSI report for BM-Case 2 may become redundant if an aperiodic CSI report is already transmitted by a WTRU since both reports may include the same information about the same set of beams. Therefore, a procedure for efficient/selective configuration and reporting of aperiodic CSI may beneficial to describe how to support aperiodic CSI for AIML Systems.

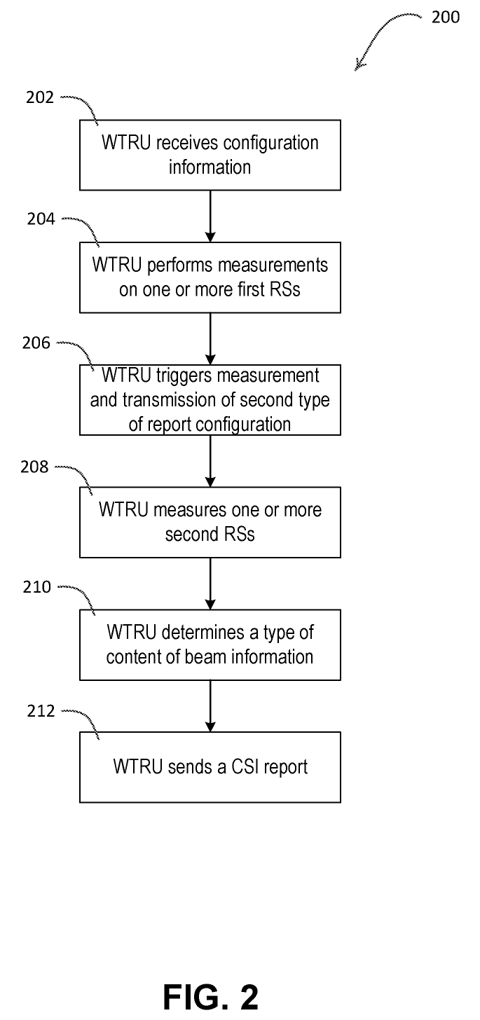

A WTRU may support aperiodic CSI for AIML systems (e.g., as shown in FIG. 2). The WTRU may receive configuration information associated with a first type of report configurations associated with a first type of resource associated with a reference signal (RS) resource set associated with one or more of an output set of predicted set of beams predicted by an artificial intelligence/machine learning (AIML) model or an input set of beams that are inputs to the AIML model, a second type of report configurations associated with one or more of a subset of the output set of predicted set of beams or the input set of beams. The configuration information may include a report quantity parameter and one or more thresholds associated with one or more of prediction quality or probability information. The WTRU may measure one or more first RSs associated with the first type of report configuration based on the received configuration information. The WTRU may determine one or more predicted beams based on the measured one or more first RSs. The WTRU may determine one or more of a prediction quality or probability information associated with the one or more predicted beams. The WTRU may trigger measurement associated with the second type of report configuration based on a received index of associated report configuration information list. The WTRU may activate one or more second type of report configurations based on one or more of the determined prediction quality or the determined probability information. The WTRU may activate one or more RS resource sets associated with the activated one or more second type of report configurations based on one or more of an active beam or an overlap between RSs associated with the second type of report configuration and RSs associated with the predicted beams. The WTRU may send a channel state information (CSI) report associated with the first type of report configuration.

The report quantity parameter may include one or more of an AIML CSI-RS resource indicator (AIML-cri) parameter, an AIML-cri-top1 parameter, an AIML CRI reference signal received power (AIML-cri-RSRP) parameter, an AIML-cri-RSRP-top1 parameter, a none parameter, a cri-RSRP parameter, a synchronization signal block (SSB) index-RSRP (ssb-index-RSRP) parameter, a CRI rank indicator (cri-RI) parameter, a CRI pre-coding matrix indicator (cri-PMI) parameter, or a CRI channel quality indicator (cri-CQI) parameter. The active beam may include a RS resource set associated with a RS QCL-TypeD related with a latest transmission of a physical downlink shared channel (PDSCH) and a physical downlink control channel (PDCCH). The WTRU may measure one or more second RSs of the one or more activated RS resource sets to determine second RS measurements. The WTRU may determine measured beam qualities based on the second RS measurements. The measured beam qualities may include one or more of reference signal received power (RSRP), signal to noise ratio (SINR), or noise power. The WTRU may update beam qualities of one or more first RSs associated with first type of report config and QCL-TypeD related with one or more second RSs associated with second type of report, for example, based on the second RS measurements of the activated one or more RS resource sets.

The first type of resource and the first type of report configuration may include periodic or semi-persistent and the second type of resource. The second type of report configuration may include aperiodic. The first CSI report may include an indication indicating that beam information is updated. The WTRU may send a second CSI report associated with the second type of report configuration. The second CSI report may include beam information. The WTRU may send a third CSI report that omits the beam information transmitted in the second CSI report of a second type of report configuration. The third CSI report may include an indication indicating the omission of the beam information in the third CSI report. The WTRU may determine a type of content of beam information to be reported in the second CSI report based on report quantity parameter in the configuration information.

FIG. 2 is a flow chart depicting an example method 200 of supporting efficient configuration and reporting of aperiodic channel state information (CSI). At 202, a WTRU may receive a configuration (e.g., configuration information) of periodic/semi-persistent and aperiodic reports. The WTRU may measure a subset of Set B RSs associated with the aperiodic report. Based on the measurements, the WTRU may update one or more measurements of RSs associated with periodic/semi persistent report, measured prior to measurement RSs associated with aperiodic report. The WTRU may determine updated beam information based on updated RS measurements. The WTRU may transmit updated beam information in periodic and/or aperiodic CSI-report and omits redundant transmission of beam information between two types of reports.

A WTRU may receive a configuration (e.g., configuration information via RRC/MAC-CE/DCI) of two or more CSI report configs. The WTRU may receive a configuration (e.g., configuration information via RRC/MAC-CE/DCI) of one or more first type (e.g., periodic and/or semi-persistent) of report config(s) associated with first type of resource (e.g., periodic and/or semi-periodic CSI resource), associated with RS resource set(s) associated with Set B/Set A. The WTRU may receive a configuration (e.g., configuration information via RRC/MAC-CE/DCI) of one or more second type (e.g., aperiodic) of report config(s), associated with first type and/or second type (e.g., aperiodic) of CSI-resource associated with a subset of Set B/Set A. The RSs associated with second type of resource may be configured with the same or similar transmission parameters (e.g., number of ports, power boosting, bandwidth, RS density, RE pattern etc.) as the RSs associated with the first type of resource. The RSs associated with the second type of resource may be QCL-TypeD related with the RSs associated with the first type of resource.

The WTRU may be configured with one or combination of two or more of the following options for a report Quantity parameter: AIML-cri, AIML-cri-top1, AIML-cri-RSRP, AIML-cri-RSRP-top1, “none”, cri-RSRP, ssb-index-RSRP, cri-RI, cri-PMI, cri-CQI etc.

The WTRU may receive a configuration (e.g., configuration information via RRC/MAC-CE/DCI) of one or more thresholds associated with prediction quality, probability information. The WTRU may receive a configuration (e.g., configuration information via RRC/MAC-CE/DCI) of one or more report parameters associated with an inference CSI-report e.g., number of predicted beams, denoted by K, and/or of number of multiple future time instances, denoted by N.

At 204, the WTRU may perform one or more measurements on one or more first RSs associated with first type of report config, and Set B and/or Set A based on the received configuration. The WTRU may determine the measured beam qualities (e.g., RSRP, SINR, noise power) based on the first RS measurements. The WTRU may determines one or more of the following based on first RS measurements associated to Set B. The WTRU may determine one or more Top-K spatially predicted beams and/or RSRPs (e.g., of RSs associated with Set A or Set B). The WTRU may determine one or more of the following Top-K temporally predicted beams and/or RSRPs (e.g., of RSs associated with Set A or Set B) for one or more future time instances (e.g., for one or more slots/frames etc.). The WTRU may determine a prediction quality and/or probability information of predicted beams.

At 206, the WTRU may trigger measurement and transmission of a second type of report config based on reception of indication (e.g., index of associatedReportConfigInfoList) via DCI and/or MAC-CE.

The WTRU may activate (e.g., for RS measurement) one or more second type of report configs based on determined prediction quality and/or probability information of predicted beams associated with the first type of report config.

The WTRU may activate one or more RS resource sets associated with activated second type of report configs based on the overlap (e.g., largest overlap) between RSs associated with the second type of report config and RSs associated with the measured/predicted beams indicated in a first CSI report. Additionally or alternatively, the WTRU may activate one or more RS resource sets associated with activated second type of report configs based on a currently active beam (e.g., RS resource set associated with RS QCL-TypeD related with latest transmission of PDSCH and PDCCH).

At 208, the WTRU may measure one or more second RSs of the one or more activated RS resource sets. The WTRU may determine the measured beam qualities (e.g., RSRP, SINR, noise power) based on second RS measurements. Based on the second RS measurements of the one or more activated RS resource sets, the WTRU may update beam qualities of one or more first RSs associated with first type of report config and QCL-TypeD related with one or more second RSs associated with second type of report.

The WTRU may update predicted Top-K beam indexes and/or RSRPs based on updated measurements.

At 210, the WTRU may determine a type of content of beam information to be reported in a CSI-report, for example, based on the configured report Quantity parameter. The WTRU may report updated (e.g., based on one or more second RS measurements associated with second type of report config) beam information in one or more CSI reports, for example, based on the received configuration in one or more of the following ways.

At 212, the WTRU may transmit a second CSI report (e.g., including beam information) of a first type of report config and may drop transmission of a CSI report of a second type of report config (e.g., when reportQuantity is set to “none”). The WTRU may send an indication indicating beam information in a CSI report of a first type of report config is updated. The WTRU may transmit a third CSI report (e.g., including beam information) of a second type of report config. The WTRU may omit the beam information transmitted in the third CSI report of a second type of report config, in the transmission of a (e.g., fourth) CSI report of a first type of report config. The WTRU may send an indication indicating omission of beam information in the fourth CSI report of a first type of report config.

The WTRU may update beam information (e.g., such as measured beam qualities, predicted beam indexes, and/or predicted beam qualities) based on one or more aperiodic CSI measurements for a subset of Set B. The WTRU may ensure that beam information is up to date and/or redundant beam information is omitted from CSI-reports.

Herein, ‘a’ and ‘an’ and similar phrases may be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

Artificial intelligence may be broadly defined herein as the behavior exhibited by machines. Such behavior may e.g., mimic cognitive functions to sense, reason, adapt and act.

Machine learning may refer herein to a type of algorithms that solve a problem based on learning through experience (‘data’), without explicitly being programmed (‘configuring set of rules’). Machine learning can be considered as a subset of AI. Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, unsupervised learning approach may involve detecting patterns in the data with no pre-existing labels. For example, reinforcement learning approach may involve performing sequence of actions in an environment to maximize the cumulative reward. In some solutions, it is possible to apply machine learning algorithms using a combination or interpolation of the above-mentioned approaches. For example, semi-supervised learning approach may use a combination of a small amount of labeled data with a large amount of unlabeled data during training. In this regard semi-supervised learning falls between unsupervised learning (with no labeled training data) and supervised learning (with only labeled training data).

Deep learning refers herein to class of machine learning algorithms that employ artificial neural networks (specifically DNNs) which were loosely inspired from biological systems. The Deep Neural Networks (DNNs) are a special class of machine learning models inspired by human brain wherein the input is linearly transformed and pass-through non-linear activation function multiple times. DNNs typically consists of multiple layers where each layer consists of linear transformation and a given non-linear activation functions. The DNNs can be trained using the training data via back-propagation algorithm. Recently, DNNs have shown state-of-the-art performance in variety of domains, e.g., speech, vision, natural language etc. and for various machine learning settings supervised, un-supervised, and semi-supervised. The term AIML based methods/processing may refer to realization of behaviors and/or conformance to requirements by learning based on data, without explicit configuration of sequence of steps of actions. Such methods may enable learning complex behaviors which might be difficult to specify and/or implement when using legacy methods.

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an RS (such as CSI-RS) or a SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by RRC or signaled by MAC CE or DCI. For example, a WTRU may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may also be referred to as a “beam indication”.

The WTRU may receive a first (e.g., target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a TCI (transmission configuration indicator) state. A WTRU may be indicated an association between a CSI-RS or SS block and a DM-RS by an index to a set of TCI states configured by RRC and/or signaled by MAC CE. Such indication may also be referred to as a “beam indication”.

TRP (e.g., transmission and reception point) may be interchangeably used herein with one or more of TP (transmission point), RP (reception point), RRH (radio remote head), DA (distributed antenna), BS (base station), a sector (of a BS), and a cell (e.g., a geographical cell area served by a BS). Multi-TRP may be interchangeably used herein with one or more of MTRP, M-TRP, and multiple TRPs.

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, and so forth.

A WTRU may measure and report the channel state information (CSI), wherein the CSI for each connection mode may include or be configured with one or more of following. The CSI for each connection mode may include or be configured with a CSI Report Configuration, including one or more of the following: a CSI report quantity (e.g., Channel Quality Indicator (CQI), Rank Indicator (RI), Precoding Matrix Indicator (PMI), CSI-RS Resource Indicator (CRI), Layer Indicator (LI), etc.), a CSI report type (e.g., aperiodic, semi persistent, periodic), a CSI report codebook configuration (e.g., Type I, Type II, Type II port selection, etc.), or a CSI report frequency. The CSI for each connection mode may include or be configured with a CSI-RS Resource Set, including one or more of the following CSI Resource settings: a NZP-CSI-RS Resource for channel measurement, a NZP-CSI-RS Resource for interference measurement, or a CSI-IM Resource for interference measurement. The CSI for each connection mode may include or be configured with NZP CSI-RS Resources, including one or more of the following: a NZP CSI-RS Resource ID, a periodicity and offset, QCL Info and TCI-state, or a resource mapping (e.g., number of ports, density, CDM type, etc.).

A WTRU may indicate, determine, and/or be configured with one or more reference signals. The WTRU may monitor, receive, and/or measure one or more parameters based on the respective reference signals. For example, one or more of the following may apply. The following parameters are non-limiting examples of the parameters that may be included in reference signal(s) measurements. One or more of these parameters may be included. Other parameters may be included.

SS reference signal received power (SS-RSRP) may be measured based on the synchronization signals (e.g., demodulation reference signal (DMRS) in PBCH or SSS). SS-RSRP may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

CSI-RSRP may be measured based on the linear average over the power contribution of the resource elements (RE) that carry the respective CSI-RS. The CSI-RSRP measurement may be configured within measurement resources for the configured CSI-RS occasions.

SS signal-to-noise and interference ration (SS-SINR) may be measured based on the synchronization signals (e.g., DMRS in PBCH or SSS). SS-SINR may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth)

Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth)

Sounding reference signals RSRP (SRS-RSRP) may be measured based on the linear average over the power contribution of the resource elements (RE) that carry the respective SRS.

A CSI report configuration (e.g., CSI-ReportConfigs) may be associated with a single BWP (e.g., indicated by BWP-Id), wherein one or more of the following parameters are configured: CSI-RS resources and/or CSI-RS resource sets for channel and interference measurement; a CSI-RS report configuration type including the periodic, semi-persistent, and aperiodic; a CSI-RS transmission periodicity for periodic and semi-persistent CSI reports; a CSI-RS transmission slot offset for periodic, semi-persistent, and aperiodic CSI reports; a CSI-RS transmission slot offset list for semi-persistent and aperiodic CSI reports; one or more time restrictions for channel and interference measurements; a report frequency band configuration (e.g., wideband/subband CQI, PMI, and so forth); one or more thresholds and/or modes of calculations for the reporting quantities (e.g., CQI, RSRP, SINR, LI, RI, etc.); a codebook configuration; a group based beam reporting; a CQI table; a subband size; a non-PMI port indication; a port Index; and so forth.

A CSI-RS Resource Set (e.g., NZP-CSI-RS-ResourceSet) may include one or more CSI-RS resources (e.g., NZP-CSI-RS-Resource and CSI-ResourceConfig), wherein a WTRU may be configured with one or more of the following in a CSI-RS Resource: a CSI-RS periodicity and a slot offset for periodic and semi-persistent CSI-RS Resources; a CSI-RS resource mapping to define the number of CSI-RS ports, density, CDM-type, OFDM symbol, and/or subcarrier occupancy; the bandwidth part to which the configured CSI-RS is allocated; or the reference to the TCI-State including the QCL source RS(s) and the corresponding QCL type(s).

One or more of following configurations may be used for a RS resource set: a WTRU may be configured with one or more RS resource sets. The RS resource set configuration may include one or more of following: a RS resource set ID, one or more RS resources for the RS resource set, a repetition (e.g., on or off), an aperiodic triggering offset (e.g., one of 0-6 slots), or TRS info (e.g., true or not).

One or more of following configurations may be used for RS resource: a WTRU may be configured with one or more RS resources. The RS resource configuration may include one or more of following: a RS resource ID, a resource mapping (e.g., REs in a PRB), a power control offset (e.g., one value of -8, …, 15), a power control offset with SS (e.g., -3 dB, 0 dB, 3 dB, 6 Db), a scrambling ID, a periodicity and offset, or QCL information (e.g., based on a TCI state)

In the following, a property of a grant or assignment may include one or more of the following: a frequency allocation, an aspect of time allocation, such as a duration, a priority, a modulation and coding scheme, a transport block size, a number of spatial layers, a number of transports blocks, a TCI state, CRI or SRI, a number of repetitions, whether the repetition scheme is Type A or Type B, whether the grant is a configured grant type 1, type 2, or a dynamic grant, whether the assignment is a dynamic assignment or a semi-persistent scheduling (configured) assignment, a configured grant index or a semi-persistent assignment index, a periodicity of a configured grant or assignment, a channel access priority class (CAPC), or any parameter provided in a DCI, by MAC or by RRC for the scheduling the grant or assignment.

In the following, an indication by DCI may include one or more of the following: an explicit indication by a DCI field or by RNTI used to mask CRC of the PDCCH; an implicit indication by a property such as DCI format, DCI size, Coreset, or search space, Aggregation Level, first resource element of the received DCI (e.g., index of first Control Channel Element), where the mapping between the property and the value may be signaled by RRC or MAC.

RS may be interchangeably used herein with one or more of RS resource, RS resource set, RS port and RS port group.

RS may be interchangeably used herein with one or more of SSB, CSI-RS, SRS, DM-RS, TRS, PRS, and PTRSn.

A reference signal may be interchangeably used herein with one or more of following: a sounding reference signal (SRS), a channel state information – reference signal (CSI-RS), a demodulation reference signal (DM-RS), a phase tracking reference signal (PT-RS), or a synchronization signal block (SSB).

A channel may be interchangeably used herein with one or more of following: a PDCCH, a PDSCH, a physical uplink control channel (PUCCH), a physical uplink shared channel (PUSCH), a physical random access channel (PRACH), etc.

A key performance indicator (KPI) may refer to, but not limited to, one or more of the following: signal quality (e.g., L1-RSRP, SINR, CQI, RSSI, RSRQ), prediction performance (e.g., Percentage of the Top-1 genie-aided (e.g., best) beam is one of the Top-K predicted beams), link quality (e.g., throughput, block error rate (BLER)), data distribution (e.g., mean and/or variance of measured and/or predicted beam measurements), or RSRP (e.g., L1-RSRP) difference (e.g., the difference between measured and predicted RSRP of a beam).

A signal, channel, and/or message (e.g., as in DL or UL signal, channel, and message) may be used interchangeably herein.

A RS resource set may be interchangeably used herein with a RS resource and a beam group.

Beam reporting may be interchangeably used herein with CSI measurement, CSI reporting, and/or beam measurement.

The proposed solutions for beam resources prediction may be used herein for beam resources belonging to a single or multiple cells as well as single or multiple TRPs.

CSI reporting may be interchangeably used herein with CSI measurement, beam reporting, and/or beam measurement.

A RS resource set may be interchangeably used herein with a beam group.

Set B may be interchangeably used herein with a set of - RS resource sets, beams, beam-pairs, beam RS resources, RS resources, and/or a beam pattern.

Set B may be interchangeably used herein with measurement RS resources, measurement RS resource set, measurement beam resources, measurement beam resource set, measurement beam pattern, measurement TCI states, measurement TCI state group, etc.

Set A may be interchangeably used herein with a set of - RS resource sets, beams, beam-pairs, beam RS resources, RS resources, and/or a beam pattern.

Beam prediction accuracy may be interchangeably used herein with prediction accuracy.

A WTRU may receive (e.g., via RRC, MAC-CE and/or DCI) a configuration of two or more report (e.g., CSI-report) configurations. In examples, the WTRU may receive one or more configuration(s) of a first type of report. For example, the WTRU may receive a configuration of periodic and/or semi-persistent CSI-report. The first type of report may be associated with a first type of resource config. For example, periodic CSI report may be associated with periodic CSI resource. For example, semi-persistent CSI-report may be associated with periodic and/or semi-periodic CSI resource. The first type of CSI-resource may be associated with one or more RS resource sets associated with Set B. In another example, the first type of CSI-resource may be associated with two or more RS resource sets wherein one or more RS resource sets may be associated with Set B and one more RS resource sets may be associated with Set A.

In examples, the WTRU may receive one or more configuration(s) of a second type of report. For example, the WTRU may receive a configuration of one or more aperiodic CSI-report. The second type (e.g., aperiodic report) of report may be associated with one or more of the first type of resource. The first type of resource may be associated with Set B and/or Set A. For example, aperiodic CSI report may be associated with the configured periodic and/or semi-periodic CSI-resource wherein RS resource set associated with CSI-resource(s) may be associated with Set B and/or Set A. The second type of report may be associated with a second type (e.g., aperiodic CSI) of resource. For example, aperiodic CSI-report may be associated with aperiodic CSI resource. The RS resource sets associated with the second type of resource may be associated with a subset of Set B. The RSs associated with the second type of resource may be configured in or more of the following ways: the RSs associated with the second type of resource may be configured with same/similar transmission parameters (e.g., number of ports, power boosting, bandwidth, RS density, RE pattern etc.) as the RSs associated with the first type (e.g., periodic and/or semi-periodic CSI) of resource and/or the RSs associated with the second type of resource may be QCL-TypeD related with the RSs associated with the first type of resource.

In examples, the second type of resource may be configured with a duration, D, (e.g., msec, slots, frames) parameter. In a solution, the second type of resource may be configured with a number of repetition, R, parameter indicating the number of times RS resource sets associated with the resource may be measured.

A WTRU may receive (e.g., via RRC, MAC-CE and/or DCI) a configuration of one or more report configs may include a parameter (e.g., reportQuantity) indicating one or more types of information to be included in the CSI-report. In an example solution, the WTRU may be configured with one or a combination of two or more of the following option for the reportQuantity parameter: AIML-cri (e.g., indication of the index of a predicted beam RS); AIML-cri-top1 (e.g., indication of the index of a highest quality predicted beam RS); AIML-cri-RSRP (e.g., indication of the predicted RSRP of a beam RS); AIML-cri-RSRP-top1 (e.g., indication of the highest predicted RSRP of a beam RS); “none” (e.g., indicating omission of beam information from a report or skip transmission of a CSI-report); cri-RSRP; ssb-index-RSRP; cri-RI; cri-PMI; cri-CQI; etc.

A WTRU may receive (e.g., via RRC, MAC-CE and/or DCI) a configuration of one or more thresholds associated with prediction quality (e.g., prediction accuracy). One or more thresholds associated with probability information.

A WTRU may receive (e.g., via RRC, MAC-CE and/or DCI) a configuration of one or more report parameters associated with an inference CSI-report (e.g., report for which reportQuantity parameter’s configuration may include AIML-cri and/or AIML-cri-RSRP). For example, the WTRU may receive a configuration parameter for number of predicted beams, denoted by K, to be reported in an inference CSI-report. For example, the WTRU ay receive a configuration of number of multiple future time instances, denoted by N, to be included in an inference CSI-report.

In examples, a WTRU may perform measurements on RSs associated with first type of report (e.g., RSs associated periodic CSI and/or semi-persistent CSI report e.g., RSs associated with periodic and/or semi-periodic CSI-resource) and Set B and/or Set A. Based on the measurements, the WTRU may determine measured beam qualities (e.g., RSRP, noise power) of measured RSs associated to Set B and/or Set A. Based on the measurements associated to beams/RSs associated to Set B, the WTRU may determine one or more of the following: one or more predicted best (e.g., beams with highest RSRP) beams: The WTRU may perform one or more temporal and/or spatial predictions of beam indices of Top-K highest quality beams; one or more predicted qualities (e.g., RSRPs): The WTRU may perform one or more (e.g., Top-K) temporal and/or spatial predictions of RSRPs of beams associated to Set A (e.g., also including Set B). Hereafter, a predicted beam quality/predicted RSRP may refer to a beam quality/RSRP associated to a beam, not obtained by directly measuring the RS associated to a beam (e.g., obtained by AIML model and/or through other filtering/signal processing techniques performed on RS measurements by the WTRU).

In examples, the WTRU may receive an indication (e.g., via DCI and/or MAC-CE and/or RRC) that may act as a trigger for transmission of the second type (e.g., aperiodic CSI-report) of CSI-report. For example, the WTRU receive may receive an indication of an index of associatedReportConfigInfoList within aperiodicTriggerStateList-setup via DCI and/or MAC-CE. To that end, the WTRU may trigger measurement of RSs associated with the second type of CSI-report. In a solution, the WTRU may activate one or more second type of report configs associated with the received indication (e.g., associatedReportConfigInfoList index). Hereafter, the activation of a report config may denote selection of the report config for measurement of RSs associated with the report config and transmission of CSI-report associated with the report config. In a solution, the WTRU may activate one or more of the RS resource sets associated with the activated report configs. Hereafter, the activation of an RS resource set may denote the selection of the RS resource set for measurement of RSs associated with the RS resource set.

In examples, the WTRU may activate all report configs associated with the received indication (e.g., associatedReportConfigInfoList index). In another solution, the WTRU may activate a subset of report configs (e.g., second type of report configs) associated with the received indication based on one or more of the following:

Indicated prediction quality (e.g., Top-K/Top-1 beam prediction accuracy, RSRP difference etc.) in a previously (e.g., latest) transmitted CSI-report (e.g., inference report): In an example solution, the WTRU may activate a first report config (e.g., first report config of second type of report e.g., aperiodic CSI-report config) based on the condition that the latest indicated prediction quality by the WTRU > first prediction quality threshold. Similarly, the WTRU may activate a second report config (e.g., of second type of report) based on the condition that the indicated prediction quality by the WTRU is less than the first prediction quality threshold.

Indicated probability information (e.g., probability of Top-1 beam being the best beam, e.g., average probability of Top-K beams being the best beam, e.g., average probability of a Top-K beam being the K-th best beam) in a previous (e.g., latest) CSI-report (e.g., inference report): In an example solution, the WTRU may activate a first report config (e.g., first report config of second type of report e.g., aperiodic CSI-report config) based on the condition that the latest indicated probability information by the WTRU > first prediction quality threshold. Similarly, the WTRU may activate a second report config (e.g., of second type of report) based on the condition that the indicated probability information by the WTRU is less than the first prediction quality threshold.

In examples, the WTRU may activate one or more (e.g., all) RS resource sets associated with the activated report config(s). In another solution, the WTRU may activate a subset of RS resource sets associated with the activated report config(s) based on one or more of the following. The WTRU may activate a subset of RS resource sets associated with the activated report config(s) based on an overlap of an RS resource set with the previously (e.g., in latest CSI-report) indicated measured/predicted beam RSs: In an example solution, the WTRU may activate one or more RS resource sets that may contain the highest number of RSs associated with the measured/predicted beams indicated (e.g., RSs associated with the Top K measured/predicted beams) in the latest CSI-report. The WTRU may activate a subset of RS resource sets associated with the activated report config(s) based on a currently active beam. In examples, the WTRU may activate the RS resource set associated with currently active downlink beam (e.g., RS QCL-TypeD related with the latest transmission of PDCCH, PDSCH).

In examples, the WTRU may receive an indication (e.g., via DCI and/or MAC-CE and/or RRC) of a second type of resource (e.g., aperiodic CSI-resource) that may as a trigger for measurement of RSs associated with the indicated CSI-resource. In a solution, the WTRU may activate all RS resource sets associated with the indicated CSI-resource. In another solution, the WTRU may activate a subset of RS resource sets associated with the indicated CSI-resource based on currently active beam and/or overlap of an RS resource set with the previously indicated measured/predicted beam RSs (refer to the procedure to RS resource sets associated with activated report configs).

The WTRU may perform measurements on RSs associated with second type (e.g., aperiodic) of report/resource, and Set B and/or Set A. For example, RSs associated with activated RS resource sets associated with activated report configs. Based on the measurements, the WTRU may update measured beam qualities (e.g., RSRP, noise power) of previously (e.g., latest measurement prior to measurement of RSs associated with aperiodic CSI report/resource) measured RSs (e.g., RS associated with first type of report e.g., RSs associated with the first report type which are QCL-TypeD related with measured RSs of the second report type) associated to Set B and/or Set A. Based on the new set of measurements (e.g., may include updated measurements for beam RSs associated with second type (e.g., aperiodic) of report/resource) associated to beams/RSs associated to Set B, the WTRU may update its previous (e.g., latest prediction prior to measurement of RSs associated with aperiodic CSI report/resource) prediction of beams and beam qualities.

The WTRU may repeat measurement of RSs associated second type of resource (e.g., indicated resource and/or resource associated with activated report) based on the received configuration. For example, the WTRU may repeat measurement of RSs associated with the aperiodic CSI resource R times with a period of D duration.

The WTRU may determine the type of content of a CSI-report (e.g., beam management associated information, beam RS measurement/prediction information), hereafter denoted by beam information, based on the received configuration. In an example solution the WTRU may determine beam information as indication of measured and/or predicted beams RS (e.g., Top-1 and/or Top-K) and/or measured and/or predicted beam RS qualities (e.g., Top-1 and/or Top-K) or “none” based on the configured reportQuantity parameter.

The WTRU may report beam information in one or more CSI reports based on the received configuration in one or more of the following ways:

The WTRU may transmit a first type (e.g., periodic or semi-persistent) of CSI report reporting updated beam information (e.g., updated beam information based on updated RS measurements associated with second type (aperiodic) of CSI report/resource). The WTRU may skip transmission of second type of report (e.g., when reportQuantity is set to “none”).

The WTRU may send an indication indicating that beam information in first type of CSI-report is updated based on the RS measurements associated with second type of CSI report/resource.

The WTRU may transmit a second type of CSI-report reporting beam information (e.g., updated beam information based on updated RS measurements associated with second type (aperiodic) of CSI report/resource).

The WTRU may omit report of a subset of beam information from the first type of CSI-report (e.g., from next periodic and/or semi-persistent CSI-report), for example, based on the content of beam information reported in the second type of CSI-report.

The WTRU may omit beam information reported in a previous (e.g., latest) second type of CSI-report from the next transmission of first type of CSI-report, for example, based on the condition that beam information reported in the previous transmission of second type of CSI-report (e.g., latest transmission of aperiodic CSI-report) is a subset of beam information configured for the next first type of CSI-report. Additionally or alternatively, the WTRU may send an indication indicating omission of beam information in the first type of CSI-report.

A WTRU may receive a configuration (e.g., via RRC/MAC-CE/DCI) of two or more CSI report configs. One or more first type (e.g., periodic and/or semi-persistent) of report config(s) may be associated with a first type of resource (e.g., periodic and/or semi-periodic CSI resource) and/or associated with one or more RS resource set(s) associated with Set B/Set A. One or more second type (e.g., aperiodic) of report config(s), may be associated with a first type and/or a second type (e.g., aperiodic) of CSI-resource associated with a subset of Set B/Set A. The RSs associated with second type of resource may be configured with same or similar transmission parameters (e.g., number of ports, power boosting, bandwidth, RS density, RE pattern etc.) as the RSs associated with the first type of resource. The RSs associated with second type of resource may be QCL-TypeD related with the RSs associated with the first type of resource. The WTRU may be configured with one or a combination of two or more of the following options for reportQuantity parameter: AIML-cri, AIML-cri-top1, AIML-cri-RSRP, AIML-cri-RSRP-top1, “none”, cri-RSRP, ssb-index-RSRP, cri-RI, cri-PMI, cri-CQI, etc.

The WTRU may receive a configuration (e.g., via RRC/MAC-CE/DCI) of one or more thresholds associated with prediction quality and/or probability information. A WTRU may receive a configuration (e.g., via RRC/MAC-CE/DCI) of one or more report parameters associated with an inference CSI-report (e.g., number of predicted beams, denoted by K, and/or of number of multiple future time instances, denoted by N).

The WTRU may perform measurements on one or more first RSs associated with the first type of report configuration, and Set B and/or Set A based on the received configuration. The WTRU may determine the measured beam qualities (e.g., RSRP, SINR, noise power) based on the first RS measurements. The WTRU may determine one or more of the following based on first RS measurements associated to Set B: top-K spatially predicted beams and/or RSRPs (e.g., of RSs associated with Set A or Set B); top-K temporally predicted beams and/or RSRPs (e.g., of RSs associated with Set A or Set B) for one or more future time instances (e.g., for one or more slots/frames etc.); a prediction quality of predicted beam(s); and/or probability information of predicted beam(s).

The WTRU may trigger measurement and/or transmission of a second type of report config based on reception of indication (e.g., index of associatedReportConfigInfoList) via DCI and/or MAC-CE. The WTRU may activate (for RS measurement) one or more second type of report configs based on a determined prediction quality and/or probability information of the predicted beam(s) associated with the first type of report config. The WTRU may activate one or more RS resource sets associated with an activated second type of report configs based on the overlap (e.g., largest overlap) between RSs associated with the second type of report config and RSs associated with the measured/predicted beams indicated in a first CSI report. The WTRU may activate one or more RS resource sets associated with an activated second type of report configs based on a currently active beam (e.g., RS resource set associated with RS QCL-TypeD related with latest transmission of PDSCH and PDCCH).

The WTRU may measure one or more second RSs of the one or more activated RS resource sets. The WTRU may determine the measured beam qualities (e.g., RSRP, SINR, noise power) based on second RS measurements. Based on the second RS measurements of the one or more activated RS resource sets, the WTRU may update beam qualities of one or more first RSs associated with first type of report config and QCL-TypeD related with one or more second RSs associated with second type of report. The WTRU may update one or more predicted Top-K beam indexes and/or RSRPs based on updated measurements.

The WTRU may determine a type of content of beam information to be reported in a CSI-report, for example, based on the configured reportQuantity parameter. The WTRU may report updated (based on one or more second RS measurements associated with second type of report config) beam information in one or more CSI reports based on the received configuration in one or more of the following ways. The WTRU may transmit a second CSI report (e.g., including beam information) of a first type of report config and/or may drop transmission of a CSI report of a second type of report config (e.g., when reportQuantity is set to “none”). The WTRU may send an indication indicating beam information in a CSI report of a first type of report config is updated. The WTRU may transmit a third CSI report (e.g., including beam information) of a second type of report config. The WTRU may omit the beam information transmitted in the third CSI report of a second type of report config, in the transmission of a (e.g., fourth) CSI report of a first type of report config. The WTRU may send an indication indicating omission of beam information in the fourth CSI report of a first type of report config.

1. A wireless transmit/receive unit (WTRU) comprising:
a memory and a processor, wherein the processor is configured to:
receive configuration information associated with a first type of report configurations associated with a first type of resource associated with a reference signal (RS) resource set associated with one or more of an output set of predicted set of beams predicted by an artificial intelligence machine learning (AIML) model or an input set of beams that are inputs to the AIML model, a second type of report configurations associated with one or more of a subset of the output set of predicted set of beams or the input set of beams, wherein the configuration information comprise a report quantity parameter and one or more thresholds associated with one or more of prediction quality or probability information;
measure one or more first RSs associated with the first type of report configuration based on the received configuration information;
determine one or more predicted beams based on the measured one or more first RSs;
determine one or more of a prediction quality or probability information associated with the one or more predicted beams;
trigger measurement associated with the second type of report configuration based on a received index of associated report configuration information list;
activate one or more second type of report configurations based on one or more of the determined prediction quality or the determined probability information;
activate one or more RS resource sets associated with the activated one or more second type of report configurations based on one or more of an active beam or an overlap between RSs associated with the second type of report configuration and RSs associated with the predicted beams; and
send a channel state information (CSI) report associated with the first type of report configuration.

2. The WTRU of claim 1, wherein the report quantity parameter comprises one or more of an AIML CSI-RS resource indicator (AIML-cri) parameter, an AIML-cri-top1 parameter, an AIML CRI reference signal received power (AIML-cri-RSRP) parameter, an AIML-cri-RSRP-top1 parameter, a none parameter, a cri-RSRP parameter, a synchronization signal block (SSB) index-RSRP (ssb-index-RSRP) parameter, a CRI rank indicator (cri-RI) parameter, a CRI pre-coding matrix indicator (cri-PMI) parameter, or a CRI channel quality indicator (cri-CQI) parameter.

3. The WTRU of claim 2, wherein the active beam comprises a RS resource set associated with a RS QCL-TypeD related with a latest transmission of a physical downlink shared channel (PDSCH) and a physical downlink control channel (PDCCH).

4. The WTRU of claim 1, wherein the processor is further configured to measure one or more second RSs of the one or more activated RS resource sets to determine second RS measurements.

5. The WTRU of claim 4, wherein the processor is further configured to determine measured beam qualities based on the second RS measurements, wherein the measured beam qualities comprise one or more of reference signal received power (RSRP), signal to noise ratio (SINR), or noise power.

6. The WTRU of claim 5, wherein the processor is further configured to update beam qualities of one or more first RSs associated with first type of report config and QCL-TypeD related with one or more second RSs associated with second type of report, based on the second RS measurements of the activated one or more RS resource sets.

7. The WTRU of claim 1, wherein the first type of resource comprises a periodic or semi-persistent CSI-RS resource and the first type of report configuration comprises a periodic or semi-persistent CSI report, and wherein the second type of resource comprises an aperiodic CSI-resource and the second type of report configuration comprises an aperiodic CSI report.

8. The WTRU of claim 1, wherein the first CSI report comprises an indication indicating that beam information is updated.

9. The WTRU of claim 1, wherein the processor is further configured to:
send a second CSI report associated with the second type of report configuration, the second CSI report comprising beam information;
send a third CSI report that omits the beam information sent in the second CSI report, wherein the third CSI report comprises an indication indicating the omission of the beam information in the third CSI report.

10. The WTRU of claim 1, wherein the processor is further configured to determine a type of content of beam information to be reported in the second CSI report based on report quantity parameter in the configuration information.

11. A method performed by a wireless transmit/receive unit (WTRU), the method comprising:
receiving configuration information associated with a first type of report configurations associated with a first type of resource associated with a reference signal (RS) resource set associated with one or more of an output set of predicted set of beams predicted by an artificial intelligence machine learning (AIML) model or an input set of beams that are inputs to the AIML model, a second type of report configurations associated with one or more of a subset of the output set of predicted set of beams or the input set of beams, wherein the configuration information comprise a report quantity parameter and one or more thresholds associated with one or more of prediction quality or probability information;
measuring one or more first RSs associated with the first type of report configuration based on the received configuration information;
determining one or more predicted beams based on the measured one or more first RSs;
determining one or more of a prediction quality or probability information associated with the one or more predicted beams;
triggering measurement associated with the second type of report configuration based on a received index of associated report configuration information list;
activating one or more second type of report configurations based on one or more of the determined prediction quality or the determined probability information;
activating one or more RS resource sets associated with the activated one or more second type of report configurations based on one or more of an active beam or an overlap between RSs associated with the second type of report configuration and RSs associated with the predicted beams; and
sending a channel state information (CSI) report associated with the first type of report configuration.

12. The method of claim 11, wherein the report quantity parameter comprises one or more of an AIML CSI-RS resource indicator (AIML-cri) parameter, an AIML-cri-top1 parameter, an AIML CRI reference signal received power (AIML-cri-RSRP) parameter, an AIML-cri-RSRP-top1 parameter, a none parameter, a cri-RSRP parameter, a synchronization signal block (SSB) index-RSRP (ssb-index-RSRP) parameter, a CRI rank indicator (cri-RI) parameter, a CRI pre-coding matrix indicator (cri-PMI) parameter, or a CRI channel quality indicator (cri-CQI) parameter.

13. The method of claim 12, wherein the active beam comprises a RS resource set associated with a RS QCL-TypeD related with a latest transmission of a physical downlink shared channel (PDSCH) and a physical downlink control channel (PDCCH).

14. The method of claim 11, further comprising measuring one or more second RSs of the one or more activated RS resource sets to determine second RS measurements.

15. The method of claim 14, further comprising determining measured beam qualities based on the second RS measurements, wherein the measured beam qualities comprise one or more of reference signal received power (RSRP), signal to noise ratio (SINR), or noise power.

16. The method of claim 15, further comprising updating beam qualities of one or more first RSs associated with first type of report config and QCL-TypeD related with one or more second RSs associated with second type of report, based on the second RS measurements of the activated one or more RS resource sets.

17. The method of claim 11, wherein the first type of resource comprises a periodic or semi-persistent CSI-RS resource and the first type of report configuration comprises a periodic or semi-persistent CSI report, and wherein the second type of resource comprises an aperiodic CSI-resource and the second type of report configuration comprises an aperiodic CSI report.

18. The method of claim 11, wherein the first CSI report comprises an indication indicating that beam information is updated.

19. The method of claim 11, further comprising:
sending a second CSI report associated with the second type of report configuration, the second CSI report comprising beam information;
sending a third CSI report that omits the beam information sent in the second CSI report, wherein the third CSI report comprises an indication indicating the omission of the beam information in the third CSI report.

20. The method of claim 11, further comprising determining a type of content of beam information to be reported in the second CSI report based on report quantity parameter in the configuration information.
